(19) United States
(12) Patent Application Publication
(10) Pub. No.: US 2018/0103805 A1
(43) Pub. Date: Apr. 19, 2018

(54) TOBACCO GRINDER

(71) Applicant: Xianhui HUANG, Shenzhen (CN)

(72) Inventor: Xianhui HUANG, Shenzhen (CN)

(21) Appl. No.: 15/294,788

(22) Filed: Oct. 17, 2016

(51) Int. Cl. A47J 42/40; A47J 42/34

(52) U.S. Cl. CPC A47J 42/40; A47J 42/34

(57) ABSTRACT

The present invention discloses a tobacco grinder comprising an upper cover, a rotary blade connected to the bottom of the upper cover, and a bottom cover. An upper ring and a lower ring are arranged between the upper cover and the bottom cover which are connected to the upper ring and the lower ring through threads correspondingly, and connected through threads; the upper ring is provided with a central through hole, and a multi-hole mesh is installed at the lower end opening of the upper ring; three feeding holes are formed in the top of the upper ring; a filter screen is installed at the bottom of the lower ring together with a compression ring. The tobacco grinder can make ground tobacco more uniform and contain more and larger tobacco and is convenient and fast to use and easy to clean, and certain components can be replaced conveniently.

### BACKGROUND OF THE INVENTION

The invention relates to grinding devices, in particular to a tobacco grinder.

An existing tobacco grinder achieves the grinding function through protruding sharp teeth of an upper cover and a lower cover and then through the rotation of the upper cover and the lower cover. The existing tobacco grinder is generally used for grinding tobacco and medicinal herbs as well as grinding perfume and weed in kitchens. Finished products ground by the existing tobacco grinder are all not uniform in size, finished products with sizes required by customers cannot be ground automatically, and certain products with large sizes are extremely difficult to cut. The existing tobacco grinder is inconvenient to use and difficult to clean.

### BRIEF SUMMARY OF THE INVENTION

For overcoming the above defects, the invention provides a tobacco grinder. By the adoption of the tobacco grinder, ground finished products can be more uniform, and since a multi-hole mesh with various holes with different sizes is arranged, the finished products with the sizes required by the customers can be ground; since the space in the tobacco grinder is large enough, users can place more and larger finished products in the tobacco grinder, and the tobacco grinder is more convenient and faster to use when used for cutting products and easier to clean.

According to the technical scheme adopted by the invention for achieving the above purposes: the tobacco grinder is characterized in that the tobacco grinder comprises an upper cover, an upper ring, a multi-hole mesh, a rotary blade, a lower ring, a filter screen, a compression ring and a bottom cover, the upper ring and the lower ring are arranged between the upper cover and the bottom cover, the upper cover and the bottom cover are connected to the top of the upper ring and the bottom of the lower ring through threads correspondingly, and the upper ring and the lower ring are connected through threads;

a central through-hole is formed in the upper ring, the rotary blade penetrates through the central through-hole to be connected to the bottom of the upper cover, three upper notches are formed in the lower end openings of the upper ring, an upper clamping opening is formed in one side of the root portion of each upper notch, three upper clamping pieces corresponding to the upper notches are arranged on the multi-hole mesh, the upper clamping pieces are clamped in the upper notches and screwed into the upper clamping openings to be fixed, and the multi-hole mesh is located at the bottom of the upper ring, so that an upper cavity provided with the rotary blade is formed in the upper ring; three feeding holes are formed in the top of the upper ring and used for feeding tobacco and perfume into the upper cavity; when the upper cover rotates, the rotary blade is driven to cut materials, three supporting beams besides the three feeding holes in the top of the upper ring squeeze the materials in the three holes onto the multi-hole mesh at the same time, and the materials come out through the holes in the multi-hole mesh, so that finished products are obtained; meanwhile, the bottom cover can contain various substances filtered out through the filter screen.

Three lower notches are formed in the bottom of the lower ring, a lower clamping opening is formed in one side of the root portion of each lower notch, three clamping pieces corresponding to the lower notches are arranged on the compression ring, the filter screen is installed at the bottom of the lower ring, the lower clamping pieces of the compression ring are clamped in the lower notches and screwed into the lower clamping openings so as to fix the filter screen, and the filter screen and the compression ring are located at the bottom of the lower ring, so that a lower cavity is formed by the lower ring. The lower cavity can be used for storing finished products cut through the multi-hole mesh, and meanwhile, certain fine powder and small components can fall into the bottom cover through the filter screen.

A chamfer is arranged at the top of the upper cover, and anti-slip grooves are formed in the side face of the upper cover so that the upper cover can be held tightly in the use process, and the rotary blade can be rotated and driven to cut the materials conveniently.

An internal hexagonal groove is formed in the inner side face of the upper cover, and the upper end of the rotary blade is arranged to be in a hexagonal shape matched with the internal hexagonal groove; when the upper cover rotates, the rotary blade is driven to rotate through the cooperation of the internal hexagon of the upper cover and the external hexagon of the rotary blade so as to be made to cut the materials in the upper ring.

The compression ring and the multi-hole mesh are each provided with three round holes, and three salient points corresponding to the round holes in the compression ring and the multi-hole mesh in position are arranged at the bottom of the bottom cover. The compression ring and the multi-hole mesh can be clamped in the clamping openings to be fixed conveniently by clamping the three salient points at the bottom of the bottom cover into the round holes in the compression ring and the multi-hole mesh when installed.

Anti-slip grooves are formed in the side face of the bottom cover, and thus in the using process, the bottom cover can be held tightly, and slipping is unlikely to occur.

Salient legs are arranged at the bottom of the bottom cover.

Compared with the prior art, the invention has the advantages that compared with the existing tobacco grinder, the tobacco grinder can make ground products more uniform; since the required multi-hole meshes can be arranged according to different requirements, products with the sizes required by customers can be obtained; since the space in the tobacco grinder is large enough, users can place more and larger products in the tobacco grinder; in addition, the tobacco grinder is more convenient and faster to use when used for cutting products and easier to clean; meanwhile, a single component can be replaced at any time without affecting the normal use of the whole tobacco grinder if damaged.

### BRIEF DESCRIPTION OF THE DRAWINGS

FIG. 1 is a breakdown structure schematic diagram of the invention.

FIG. 2 is a combined structure schematic diagram of the invention.

FIG. 3 is a structure schematic diagram of the inner side face of an upper cover of the invention.

FIG. 4 is a structure schematic diagram of the bottom surface of a bottom cover of the invention.

FIG. 5 is a structure schematic diagram of the bottom of an upper ring of the invention.

### DETAILED DESCRIPTION OF THE INVENTION

A detailed description of the invention is given as follows with accompanying drawings.

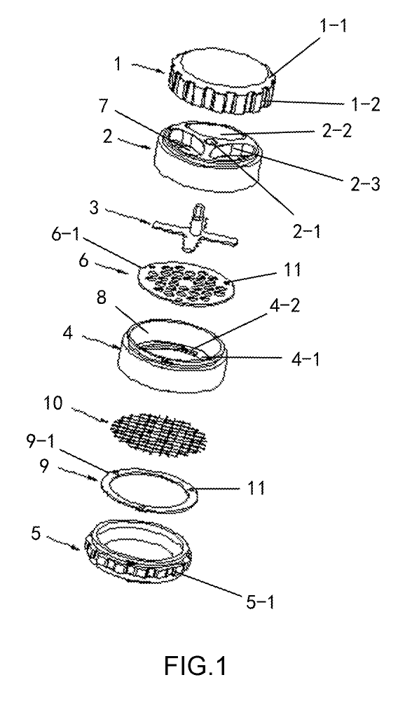

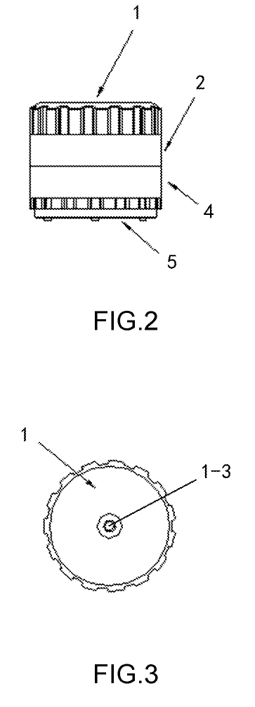

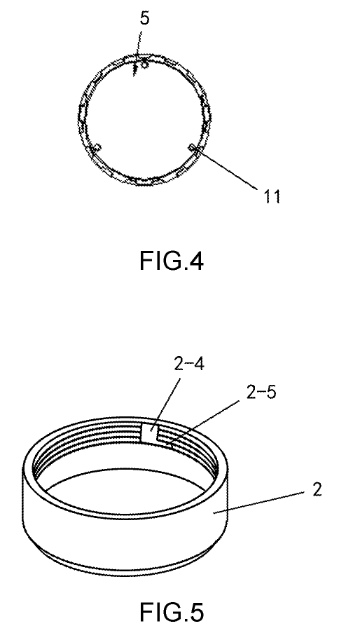

As is shown in FIG. 1 to FIG. 5, the tobacco grinder comprises an upper cover 1, an upper ring 2, a multi-hole mesh 6, a rotary blade 3, a lower ring 4, a filter screen 10, a compression ring 9 and a bottom cover 5, the upper ring 2 and the lower ring 4 are arranged between the upper cover 1 and the bottom cover 5, the upper cover 1 and the bottom cover 5 are connected to the top of the upper ring 2 and the bottom of the lower ring 4 through threads correspondingly, and the upper ring 2 and the lower ring 4 are connected through threads.

A central through-hole 2-1 is formed in the upper ring 2, the rotary blade 3 penetrates through the central through-hole 2-1 to be connected to the bottom of the upper cover 1, three upper notches 2-4 are formed in the lower end opening of the upper ring 2, an upper clamping opening 2-5 is formed in one side of the root portion of each upper notch 2-4, three upper clamping pieces 6-1 corresponding to the upper notches 2-4 are arranged on the multi-hole mesh 6, the upper clamping pieces 6-1 are clamped in the upper notches 2-4 and screwed into the upper clamping openings 2-5 to be fixed, and the multi-hole mesh 6 is located at the bottom of the upper ring 2, so that an upper cavity 7 provided with the rotary blade 3 is formed in the upper ring 2; three feeding holes 2-2 are formed in the top of the upper ring 2 and used for feeding weed and perfume into the upper cavity 7; when the upper cover 1 rotates, the rotary blade 3 is driven to cut materials, three supporting beams 2-3 besides the three feeding holes 2-2 in the top of the upper ring 2 squeeze the materials in the three holes onto the multi-hole mesh 6 at the same time, and the materials come out through the holes in the multi-hole mesh 6, so that finished products are obtained; meanwhile, the bottom cover 5 can contain various substances filtered out through the filter screen 10.

Three lower notches 4-1 are formed in the bottom of the lower ring 4, a lower clamping opening 4-2 is formed in one side of the root portion of each lower notch 4-1, three clamping pieces 9-1 corresponding to the lower notches 4-1 are arranged on the compression ring 9, the filter screen 10 is installed at the bottom of the lower ring 4, the lower clamping pieces 9-1 of the compression ring 9 are clamped in the lower notches 4-1 and screwed into the lower clamping openings 4-2 so as to fix the filter screen 10, and the filter screen 10 and the compression ring 9 are located at the bottom of the lower ring 4, so that a lower cavity is formed by the lower ring 4. The lower cavity 8 can be used for storing finished products cut through the multi-hole mesh 6, and meanwhile, certain fine powder and small components can fall into the bottom cover 5 through the filter screen 10.

A chamfer 1-1 is arranged at the top of the upper cover 1, and anti-slip grooves 1-2 are formed in the side face of the upper cover 1 so that the upper cover 1 can be held tightly in the use process, and the rotary blade 3 can be rotated and driven to cut the materials conveniently.

An internal hexagonal groove 1-3 is formed in the inner side face of the upper cover 1, and the upper end of the rotary blade 3 is arranged to be in a hexagonal shape matched with the internal hexagonal groove 1-3; when the upper cover 1 rotates, the rotary blade 3 is driven to rotate through the cooperation of the internal hexagon of the upper cover 1 and the external hexagon of the rotary blade 3 so as to be made to cut the materials in the upper ring 2.

The compression ring 4 and the multi-hole mesh 6 are each provided with three round holes 11, and three salient points 5-2 corresponding to the round holes 11 in the compression ring 4 and the multi-hole mesh 6 in position are arranged at the bottom of the bottom cover 5. The compression ring 4 and the multi-hole mesh 6 can be clamped in the upper clamping openings 2-5 and the lower clamping openings 4-2 to be fixed conveniently by clamping the three salient points 5-2 at the bottom of the bottom cover 5 into the round holes 11 in the compression ring 4 and the multi-hole mesh 6 when installed.

Anti-slip grooves 5-1 are formed in the side face of the bottom cover 5, and thus in the using process, the bottom cover can be held tightly, and slipping is unlikely to occur.

Salient legs 11 are arranged at the bottom of the bottom cover.

The above description is only embodiments of the invention, the patent scope of the invention is not limited to the above description, and all equivalent structure or equivalent flow transformations made based on the content of the description and drawings of the invention or directly or indirectly applied to other relevant technical fields are included in the patent protection scope of the invention.

What is claimed is:

1. A tobacco grinder, characterized in that the tobacco grinder comprises an upper cover, an upper ring, a rotary blade, a lower ring and a bottom cover, the upper ring and the lower ring are arranged between the upper cover and the bottom cover, the upper cover and the bottom cover are connected to the upper ring and the lower ring through threads correspondingly, and the upper ring and the lower ring are connected through threads;
a central through-hole is formed in the upper ring, the rotary blade penetrates through the central through-hole to be connected to the bottom of the upper cover, three upper notches are formed in the lower end opening of the upper ring, an upper clamping opening is formed in one side of the root portion of each upper notch, three upper clamping pieces corresponding to the upper notches are arranged on a multi-hole mesh, the upper clamping pieces are clamped in the upper notches and screwed in the upper clamping openings to be fixed, and the multi-hole mesh is located at the bottom of the upper ring, so that an upper cavity provided with the rotary blade is formed in the upper ring; three feeding holes are formed in the top of the upper ring and used for feeding tobacco and perfume into the upper cavity;
three lower notches are formed in the bottom of the lower ring, a lower clamping opening is formed in one side of the root portion of each lower notch, lower clamping pieces corresponding to the lower notches are arranged on a compression ring, a filter screen is installed at the bottom of the lower ring, the lower clamping pieces of the compression ring are clamped in the lower notches and screwed in the lower clamping openings so as to fix the filter screen, and the filter screen and the compression ring are located at the bottom of the lower ring, so that a lower cavity is formed by the lower ring.

2. The tobacco grinder according to claim 1, characterized in that a chamfer is arranged at the top of the upper cover, and anti-slip grooves are formed in the side face of the upper cover.

3. A tobacco grinder according to claim 1, characterized in that an internal hexagonal groove is formed in the inner side face of the upper cover, and the upper end of a rotary shaft of the rotary blade is arranged to be in a hexagonal shape matched with the internal hexagonal groove.

4. A tobacco grinder according to claim 1, characterized in that the compression ring and the multi-hole mesh are each provided with three round holes, and three salient points corresponding to the round holes in the compression ring and the multi-hole mesh in position are arranged at the bottom of the bottom cover.

5. The tobacco grinder according to claim 1, characterized in that anti-slip grooves are formed in the side face of the bottom cover.

6. The tobacco grinder according to claim 1, characterized in that salient legs are arranged at the bottom of the bottom cover.
